(19) United States
(12) Patent Application Publication
(10) Pub. No.: US 2011/0091699 A1
(43) Pub. Date: Apr. 21, 2011

(54) METHOD FOR MANUFACTURING A LAMINATE AND PRODUCT OBTAINED

(76) Inventor: Wilhelmus Josephus Alex Van De Wall, Heeze (NL)

(21) Appl. No.: 12/992,858

(22) PCT Filed: May 15, 2009
(86) PCT No.: PCT/NL09/00116

§ 371 Date: Jan. 5, 2011

(30) Foreign Application Priority Data
May 15, 2008 (NL) 1035423

(51) Int. Cl. B31B 1/60; B32B 37/10; C08L 61/14; B32B 3/26; B32B 7/02

(52) U.S. Cl. 428/213; 156/60; 156/273.7; 156/335; 428/314.2

(57) ABSTRACT

The present invention relates to a method for manufacturing a laminate product by assembling two substrates provided with liquid coating layers by passing said substrates between two rotating guide rollers. The object of the present invention is to provide a method for manufacturing a laminate product in which the number of process steps for applying two or more liquid layers is minimised Another object of the present invention is to provide a method for manufacturing a laminate product in which the inclusion of air between the individual layers is minimised.

The present invention relates to a method for manufacturing a laminate product which is produced by assembling two substrates provided with liquid coating layers by passing said substrates between two rotating guide rollers; the present invention further relates to the resulting laminate.

Such a method is known per se from U.S. Pat. No. 4,789,604 in the name of the present applicant. According to said document, a liquid layer is applied to a substrate, for example kraft paper, which liquid layer can be radiation-polymerised. After the liquid layer has been applied to the substrate, a plastic film is applied to the liquid layer via two guide rollers, whereupon the assembly of substrate, liquid layer and plastic film is supplied to a radiation unit, which plastic film is removed after the assembly has left the radiation unit. Subsequently, another liquid layer is applied to the substrate thus provided with a cured layer, which liquid layer is transparent. The liquid, transparent layer is subsequently coated with a plastic film, using two guide rollers, whereupon the whole is passed through a radiation unit again, after which the plastic film is removed so as to obtain a substrate provided with two cured layers. In order to thus obtain a substrate provided with two separate layers, the layers need to be applied separately as single layers in separate process steps. This means that two separate coating stations are needed for the two separate layers at all times, or that several passages through a coating station are required.

The object of the present invention is to provide a method for manufacturing a laminate product in which the number of process steps for applying two or more liquid layers is minimised.

Another object of the present invention is to provide a method for manufacturing a laminate product in which the inclusion of air between the individual layers is minimised.

Another object of the present invention is to provide a method is for manufacturing a laminate product in which the layer structure of the liquids is maintained during the provision of the second substrate upon passage between the two guide rollers.

The method as referred to in the introduction is characterised in that at least two superposed, yet uncured liquid layers are present on at least one substrate.

One or more of the above objects are accomplished by using such a method. It has been found that by providing in particular at least one of the substrates with two superposed, yet uncured liquid layers, the inclusion of air is minimised. It has moreover been found that the individual layers are not mixed or smeared together after having passed between the rotating guide rollers, so that the passage through the guide rollers has not undesirably disrupted the layer structure.

In a special embodiment, three superposed, yet uncured liquid layers are present on at least one substrate, whilst it is in particular preferable if the yet uncured liquid layers present on the substrate have been obtained by means of a curtain coating process.

Using the aforesaid curtain coating process, it is possible to impart different properties to the individual, yet uncured liquid layers, which makes it possible to produce “tailor-made” laminates. The term “yet uncured liquid layers” is understood to mean that the layers were not subjected to one or more pre-treatments prior to being passed through the rotating guide rollers. Such pre-treatments include drying steps, curing steps and/or radiation steps, which treatments are explicitly not used in the present invention. For specific information regarding the curtain coating process, reference is made to the present applicant's International application PCT/NL2007/000013, which document can be considered to be fully incorporated therein. It is in particular desirable for the liquid layers to have a viscosity such that no intermixing of the liquid layers will take place prior to the passage thereof between the guide rollers. It is in particular desirable, therefore, for the viscosity of the liquid layers to range between 200-3000 mPas, measured at a shearing rate of 1000 sec⁻¹.

Said multilayer curtain coating is carried out with a coating device provided with a die for effecting a liquid curtain consisting of a number of individual coating liquids. The die comprises a plurality of gaps or outlet openings for the coating liquid, which gaps are arranged parallel to each other and which are oriented perpendicularly to the direction of movement of the base, viz. the substrate, to which the coating liquid(s) is (are) to be passed. It is desirable to remove air inclusions and any dissolved gases from the coating liquids as much as possible, for example by applying a vacuum, before said coating liquids are supplied to the die. The length of the gap substantially corresponds to the width of the base. The base, whose surface is to be coated with the coating liquid(s) that flow(s) from the die, is continuously passed under said die by conveying means. By causing the liquid film, which exits the die in a free fall, to drop on the substrate that passes under said die, a base is obtained which is provided with a coating composed of a number of different coating liquids, which are supplied via the gaps in the die. Since the gaps are positioned one behind another, in spaced-apart relationship, seen in the direction of movement of the base, a multilayer liquid film will be developed in the die, which liquid film will already have the layer structure of the coating to be applied to the base that moves under the die upon exiting the die. The multilayer liquid film obtained as a result of the presence of several parallel outlet openings or gaps will land essentially vertically on the base passing thereunder due to the force of gravity, with the liquid film forming a curtain between the base and the die. A stable curtain can be obtained by correctly setting the process parameters, whilst at the same time preventing inclusion of air and intermixing of the at least two coatings on the base. The coating thus formed on the substrate, which consists of at least two superposed, yet uncured liquid layers, will subsequently be passed between the rotating guide rollers, the object being to provide the second substrate on the laminate, and be subjected to a treatment for curing or cross-linking the coating. The liquid layers present on the substrate will thus comprise a number of individual layers, in particular at least two layers, seen in the direction perpendicular to the substrate surface, which layers do not exhibit intermixing.

To obtain a specific degree of matting and/or scratch resistance of the assembly of the substrates with the liquid layers present therebetween, one of the substrates is preferably removed from the assembly after the curing step.

The assembly of the yet uncured liquid layers and the two substrates is subjected to an actinic radiation treatment, in particular selected from the group of EB (electron beam) and UV radiation, after being passed between the guide rollers so as to effect a cross-linking reaction in the yet uncured liquid layers, after which treatment the liquid layers are thus cured.

According to a special embodiment, three superposed, yet uncured liquid layers may be present on at least one substrate. In a specific embodiment, both substrates are preferably provided with a yet uncured liquid layer, at least one substrate being provided with at least two superposed, yet uncured liquid layers, before the two substrates are passed between the rotating guide rollers, during which passage the second substrate is provided.

Suitable substrates include a resin-impregnated decor paper and plastic films, in which case it is in particular preferable to use a phenol resin-impregnated decor paper as the substrate on which at least two superposed, yet uncured liquid layers are present. The substrates are preferably unwound from a supply roll before the two substrates are passed between the rotating guide rollers. A suitable layer thickness for the substrate is 10-300 μm, preferably 40-160 μm. A suitable substrate is a band-shaped substrate.

The present invention further relates to an assembly obtained by using the present method, wherein the amount of air bubbles having a diameter of more than 100 μm in the cured liquid layers is at most 100 per m² of substrate area, and wherein less than one air inclusion having a surface area of 0.3 mm² is present per m² of substrate area. The present assembly comprises, in succession, a substrate with cured liquid layers applied thereto and possibly a substrate which covers the cured liquid layers. Preferably, said at least two superposed cured liquid layers each have a thickness of 2-150 μm, more in particular, at least one of the cured liquid layers has a thickness of 5-50 μm. In a special embodiment, it is moreover preferable if the ratio between the thickness of said at least one substrate and the total thickness of the cured liquid layers on said at least one substrate ranges between 0.07:1 and 15:1.

The present invention further relates to the use of guide rollers for passing two substrates therebetween, wherein at least two superposed, yet uncured liquid layers are present on at least one substrate, for the purpose of minimising the occurrence of air inclusions. The spacing between the guide rollers is selected so that the two substrates touch one another and form one assembly upon exiting the passage through the guide rollers.

The amount of air bubbles having a diameter of more than 100 μm can be determined by visual evaluation of an area of 100 cm² of the substrate, using a stereomicroscope. The amount of air inclusions per 1 m² of substrate area that have a larger diameter is determined by visual evaluation of 5 m² substrate area.

The present invention will now be explained in more detail by means of a number of examples, in which connection it should be noted, however, that the present invention is by no means limited to the special data mentioned therein.

### EXAMPLE 1

Band-shaped substrate 1: phenol resin-impregnated decor paper, 126 g/m²
Coating 1: radiation curable white coating, 100 μm, viscosity 1.5 Pas
Coating 2: radiation curable transparent coating 30 μm, viscosity 1 Pas
Band-shaped substrate 2: 30 g/m² polyester film
roller diameter 1: steel roller 300 mm
roller diameter 2: rubber roller 200 mm
line pressure: 1500 N/m
machine speed: 150 m/min
result: no air inclusions, no intermixing of the individual layers.

### EXAMPLE 2

Band-shaped substrate 1: phenol resin-impregnated decor paper, 126 g/m²
Coating 1: radiation curable grey coating, 40 μm, viscosity 1.3 Pas
Coating 2: radiation curable metallic coating, 40 μm, viscosity 1.5 Pas
Coating 3: radiation curable transparent coating 30 μm, viscosity 1 Pas
Band-shaped substrate 2: 30 g/m² polyester film
roller diameter 1: steel roller 300 mm
roller diameter 2: rubber roller 200 mm
line pressure: 1500 N/m
machine speed: 150 m/min
result: no air inclusions, no intermixing of the individual layers.

1. A method for manufacturing a laminate product, comprising passing two substrates jointly between two rotating guide rollers, wherein at least two superposed, uncured liquid layers are present on at least one of the substrates.

2. The method according to claim 1, wherein three superposed, uncured liquid layers are present on at least one substrate.

3. The method according to claim 1 wherein the uncured liquid layers present on the substrate have been obtained by means of a curtain coating process prior to the passing of the two substrates between the rotating guide rollers.

4. The method according to claim 1 wherein the liquid layers have a viscosity such that no intermixing of the liquid layers will take place prior to the passing thereof between the rotating guide rollers.

5. The method according to claim 4, wherein the viscosity of the liquid layers ranges between 200 and 3000 mPas. measured at a shearing rate of 1000 sec⁻¹.

6. The method according to claim 1 wherein a crosslinking reaction of the uncured liquid layers is carried out, using actinic radiation, after the passing between the guide rollers.

7. The method according to claim 1 wherein the uncured liquid layers present on at least one substrate are not subjected to one or more drying, curing and/or radiation pre-treatments, prior to being passed between the rotating guide rollers.

8. The method according to claim 1 wherein the two substrates are provided with an uncured liquid layer, at least one of said substrates being provided with at least two superposed, uncured liquid layers, before the two substrates are passed between the rotating guide rollers.

9. The method according to claim 1 wherein the substrates are unwound from a supply roll before the two substrates are passed between the rotating guide rollers.

10. The method according to claim 1 wherein the thickness or each substrate ranges between 10 and 300 μm.

11. The method according to claim 6, wherein said actinic radiation is selected from electron beam and UV radiation.

12. The method according to claim 1 wherein one substrate is removed after the passing between the rotating guide rollers.

13. The method according to claim 1 wherein the substrates comprise at least one of decor paper, resin-impregnated paper and plastic films.

14. The method according to claim 13, wherein the substrate comprises a phenol resin-impregnated decor paper on which at least two superposed, uncured liquid layers are present.

15. The method according to claim 1 wherein the substrates are made of different materials.

16. An assembly obtained according to the method of claim 1 and comprising, in succession, a substrate with cured liquid layers applied thereto and optionally a substrate which covers the cured liquid layers, wherein an amount of air bubbles having a diameter of more than 100 μm in the cured liquid layers is at most 100 per m² of the substrate, wherein less that one air inclusion having a surface area of 0.3 mm² is present per m² of substrate area.

17. The assembly according to claim 16, comprising at least two cured liquid layers each have a thickness of 2-150 μm.

18. The assembly according to claim 17, wherein at least one of the cured liquid layers has a thickness of 5-50 μm.

19. The assembly according to claim 16 wherein the ratio between the thickness of said at least one substrate and the total thickness of the cured liquid layers on said at least one substrate ranges between 0.07:1 and 15:1.

20. The method according to claim 2 wherein the uncured liquid layers present on the substrate have been obtained by means of a curtain coating process prior to the passing of the two substrates between the rotating guide rollers.
